(19) United States
(12) Patent Application Publication
(10) Pub. No.: US 2007/0131341 A1
(43) Pub. Date: Jun. 14, 2007

(54) Method for producing an elongate hollow member comprising a mounting component

(75) Inventor: Volker Thoms, Rabenau-Oelsa (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/578,141

(22) PCT Filed: Oct. 15, 2004
(86) PCT No.: PCT/EP04/11636

§ 371 Date: Feb. 15, 2007

(30) Foreign Application Priority Data
Nov. 3, 2003 (DE) 103 51 138.5

(51) Int. Cl. B60J 10/00; B32B 37/00; B29C 65/00

(52) U.S. Cl. 156/221; 156/292; 156/304.2; 264/285

(57) ABSTRACT

A method for producing an elongate hollow member that includes a laterally protruding mounting component, the mounting component is formed from the hollow member. For this purpose the latter, at a point about a horizontal axis intersecting the central longitudinal axis of the hollow component at an angle of approximately 45°, is bent upwards or downwards at an angle of approximately 90°, such that the bent section projects transversely in relation to the longitudinal extent of the remainder of the component. The lateral projection of the bent section is then angled at an offset height in relation to the remainder of the component to form the mounting component.

### BACKGROUND AND SUMMARY OF THE INVENTION

This application is a National phase of PCT/EP2004/011636, filed Oct. 15, 2004, and claims the priority of German patent document DE 103 51 138.5, filed Nov. 3, 2003, the disclosure of which is expressly incorporated by reference herein.

The invention relates to a method for producing an elongate hollow member having a laterally protruding mounting component.

German patent document DE 196 18 626 C2 discloses such an elongate, hollow member, which serves as a motor vehicle support member. Along its length, it is connected to various types of mounting components, which protrude laterally from the support member, and are used as holders for attachments, which comprise, for example, a longitudinal column, a dashboard, a tunnel brace, and holders for a heating system, an airbag sensor and a knee protector.

In an internal high pressure forming tool the mounting components are positively gripped by expansion of the elongate, hollow member by high internal fluid pressure, firmly joining them to the hollow member. The production cost of this process is relatively high, since the elongate, hollow member and the mounting components must first be produced separately before commencing the time-consuming task of arranging them in the internal high pressure forming tool in preparation for the joining process. Furthermore, although the known joining technique is sufficient for the intended purpose of the hollow member and its mounting components in the form of holders inside the passenger compartment of a motor vehicle, it fails where the hollow member with its laterally protruding mounting component is arranged in areas of the motor vehicle which are exposed to high mechanical and thermal stresses. In this case the mounting components may readily be deformed or even break off.

One object of the invention, therefore, is to provide a method for producing an elongate, hollow member with a laterally protruding mounting component, relatively low cost.

This and other objects and advantages of the invention are achieved by bending technique according to the invention, which allows the mounting component to be formed from the elongate, hollow member without requiring any joining, and is therefore easily achieved without the need for additional components. Since manufacturing of the hollow member and the mounting component do not involve separate production processes (each of which would be subject to production tolerances that have a cumulative effect when they are assembled), the hollow member with the mounting component produced according to the invention will always have the same production tolerance. The precise component dimensions that are thus achieved substantially facilitate assembly of the hollow member and its mounting component with other components, or even make it possible to automate this process. The absence of joining seams and the forming of the mounting component from the inherently rigid, elongate hollow member, mean that the resulting structure is very rigid and resistant even to high mechanical and thermal stresses. Accordingly, the risk of fracture between the mounting component and the hollow, elongate member is extremely low.

In an especially preferred further embodiment of the invention, the elongate member is produced using two hollow profiles arranged in series, the opposing ends of which are bent upwards or downwards into an equivalent position about a horizontal axis and laterally inverted in relation to an imaginary axis transverse to the central longitudinal axis of the hollow profiles. They are then angled in the same direction, the two hollow profiles at their angled ends being joined (preferably welded) to one another to form the hollow member. This serves to substantially simplify the bending process for producing the hollow member with its protruding mounting component, since only one end of each hollow profile is bent and serves to form the mounting component. The fact that the angled ends of the hollow profiles directly adjoin one another means that it is possible to produce the mounting component with especially large mounting faces.

In another embodiment of the invention, a partial section of the bent section is bent approximately 90° forwards about a further parallel axis separated by a vertical distance from the horizontal axis parallel to the central longitudinal axis of the hollow member. The partial section is thus bent further in a lateral inversion of the preceding bending operations, until an end section of the partial section aligns with the unbent remainder of the component. This variant of the method likewise gives the mounting component a large mounting face, while at the same time avoiding any need for joining between hollow profiles as in the preceding embodiment development of the invention.

In still another embodiment of the invention, the bent section is angled into a horizontal plane. This creates a secure support for attachments or fasteners and for the elongate, hollow member itself on adjoining components, which largely prevents any slipping of the components that are to be arranged against one another.

In yet another embodiment of the invention the bent section is flattened in its angled area. This creates a plane mounting face, and affords a better support for attachments on the mounting component and for the elongate, hollow member and the mounting component on other attachments or members. The flatness of the mounting face moreover allows the mounting component to be connected more easily, securely and firmly to other attachments.

In a further embodiment of the invention, the bent section is perforated in its angled area. The perforation turns the mounting component into a seat, on which the attachments can easily be fixed by means of the usual fasteners. The seat can furthermore function as a suspension eye, into which the correspondingly formed attachments can hook.

In another embodiment of the invention, the flattening is bent downwards at a right angle at its edge that is parallel to the hollow member, which gives the mounting component a significantly increased rigidity. In addition the elongate, hollow member can be affixed to other components by the resulting hooked design shape of the mounting component.

Finally, another embodiment, after bending, the hollow member is expanded in an internal high pressure forming tool by means of a high internal fluid pressure. The expansion not only serves to even out and smooth unsightly folds and buckling produced during the bending process but, with the obvious exception of the flattened area, also restores the hollow member and the protruding mounting component to a virtually tubular shape in the bent areas. The tubular shaping gives the mounting component and hence also the elongate, hollow member an extremely high flexural and torsional rigidity.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view, which shows the details of a hollow member produced according to the invention and having a laterally protruding mounting component, comprising two hollow profiles arranged in series and joined to one another;

FIG. 2 is a perspective view of a bent shape according to the invention for an elongate, hollow member, which at a point about a horizontal axis intersecting the central longitudinal axis of the hollow member at an angle of approximately 45° is bent upwards at an angle of approximately 90°;

FIG. 3 is a perspective view of a bent shape according to the invention for an elongate, hollow member after a second bending phase following the bending according to FIG. 2;

FIG. 4 is a perspective view of an elongate, hollow member bent according to the invention in a bent shape which results from a bending process of the bent hollow member in FIG. 3;

FIG. 5 is a perspective view of the elongate, hollow member in FIG. 4 after a further bending process according to the invention forming the mounting component; and

FIG. 6 is the hollow member with laterally protruding mounting component in FIG. 5 after flattening and perforation of the mounting component produced according to the invention.

### DETAILED DESCRIPTION OF THE DRAWINGS

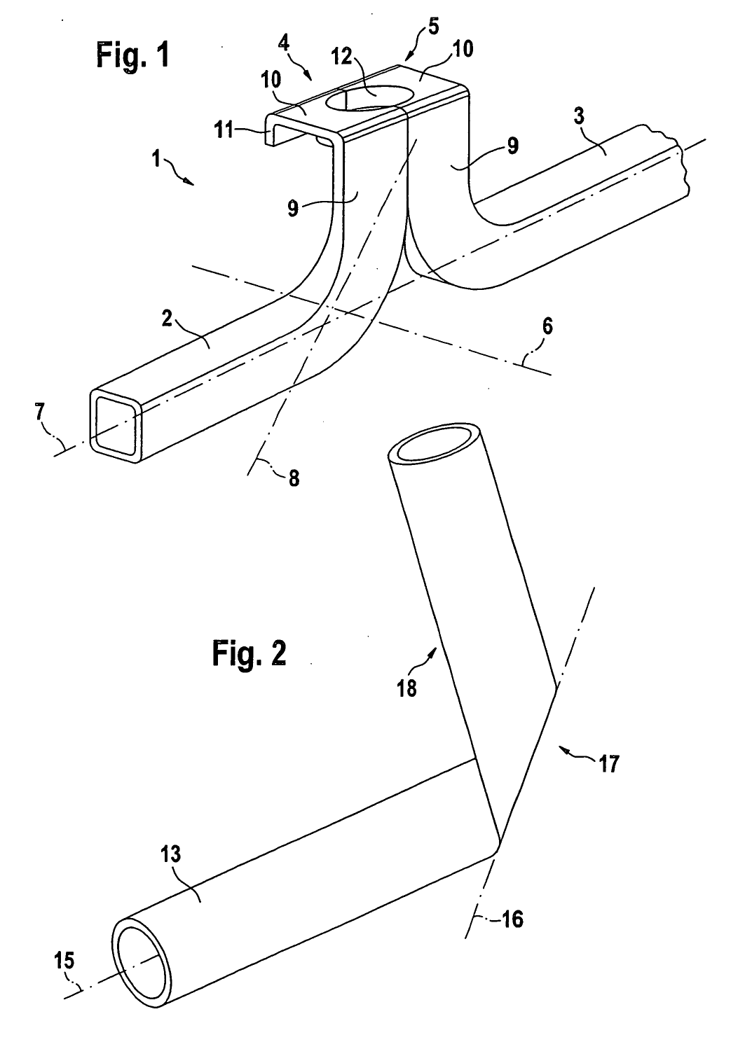

FIG. 1 shows an elongate, hollow member 1, which is made up of two hollow profiles 2 and 3 that are arranged in series. The opposing ends 4 and 5 of the profiles 2 and 3 are bent upwards at an angle of approximately 90° into an equivalent position about a horizontal axis 8, and laterally inverted in relation to an imaginary transverse axis 6 to the central longitudinal axis 7 of the hollow profiles 2 and 3, which horizontal axis intersects the central longitudinal axis 7 at an angle of approximately 45°. The sections 9 of the hollow profiles 2 and 3 bent upwards and containing the respective ends 4 and 5 are bent in such a way that the bent sections 9 project laterally in relation to the longitudinal extent of the remainder of the component 1. The lateral projection 10 of the bent section 9 is angled at 90° into a horizontal plane at an offset height in relation to the remainder of the hollow member 1.

The angling of the two bent sections 9 points in the same direction. In the area of this angling the bent section 9 is in each case flattened, the flattening at its edge 11 lying parallel to the hollow member 1 being bent downwards at a right angle. In the area of its flattened angling the bent section 9 is perforated, forming a passage 12. The perforation, preferably produced by punching, can be undertaken, for example, when the two hollow profiles 2 and 3 have been joined together at their ends 4 and 5, preferably by welding. It is also feasible, however, to undertake this before joining the two hollow profiles 2 and 3, by forming a half-hole at each end 4 and 5 respectively. The bent, angled, flattened and perforated section 9 forms the laterally protruding mounting component, which may be used, for example, as a spring strut seating in motor vehicle construction.

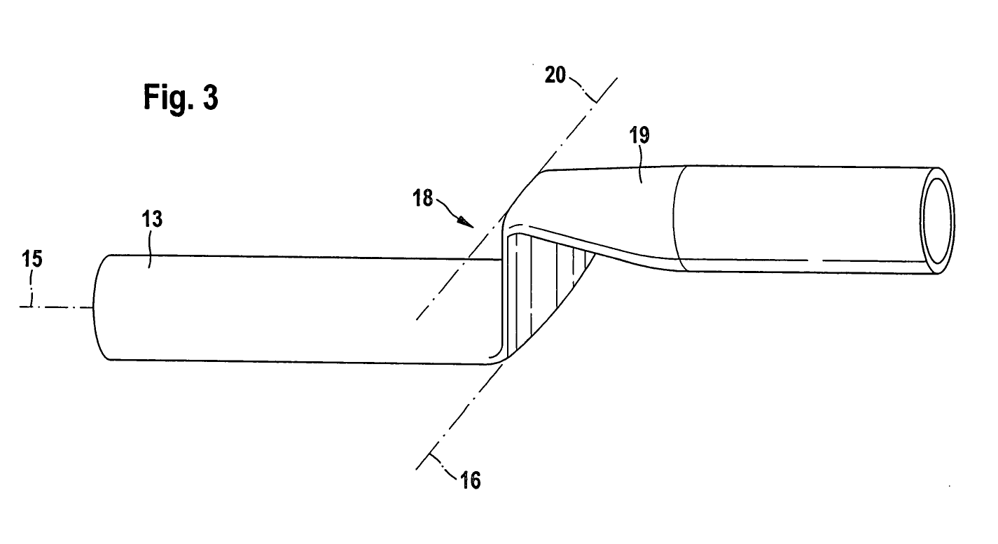

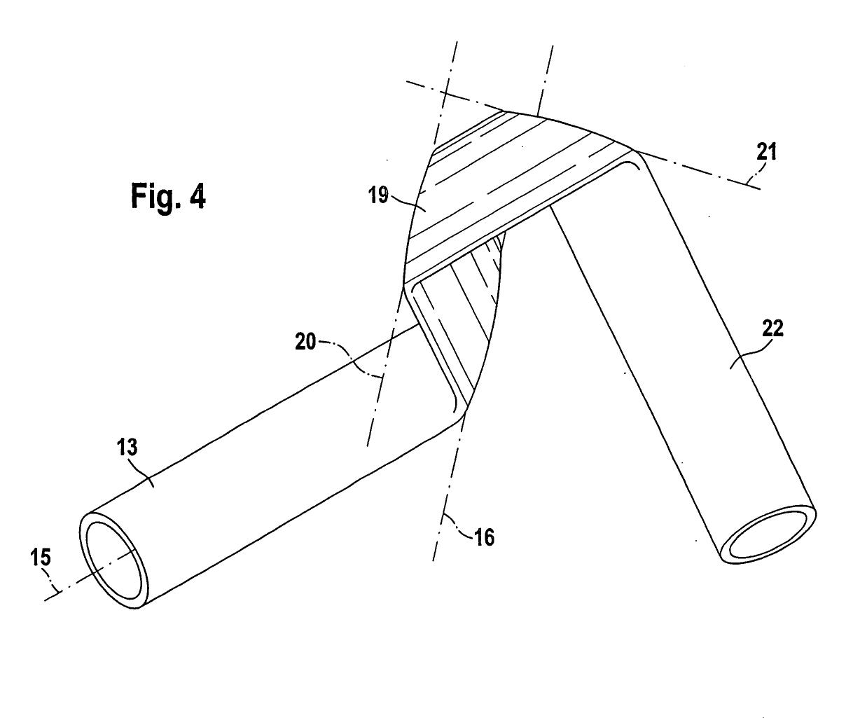

FIGS. 2 to 6 show successive stages in the progressive manufacturing of a variant of an elongate, hollow member 13 produced according to the invention and comprising a laterally protruding mounting component 14. According to FIG. 2, at a point about a horizontal axis 16 that intersects the central longitudinal axis 15 of the hollow member 13 at an angle of approximately 45°, the one-piece elongate, hollow cylindrical member 13, is bent upward at an angle of approximately 90°, with the bent section projecting laterally in relation to the longitudinal extent of the remainder of the member 13. The lateral projection 18 of the bent section 17 is then angled at an offset height in relation to the remainder of the member 13 in order to form the mounting component 14. A partial section 19 of the bent section 17 contained by the lateral projection 18 is bent forwards by approximately 90° about a further parallel axis 20 separated by a vertical distance from the horizontal axis 16, so that the partial section 19 runs parallel to the central longitudinal axis 15 of the hollow member 13 (FIG. 3). According to FIG. 4 the partial section 19 is then bent further in a lateral inversion of the preceding bending operation. For this purpose the partial section 19 is bent by approximately 90° downwards and back about a horizontal axis 21 likewise lying at the same height as the parallel axis 20 but at an angle of approximately 90° thereto, so that the free end 22 of the partial section 19 points approximately in a transverse direction to the longitudinal extent of the unbent part of the member 13.

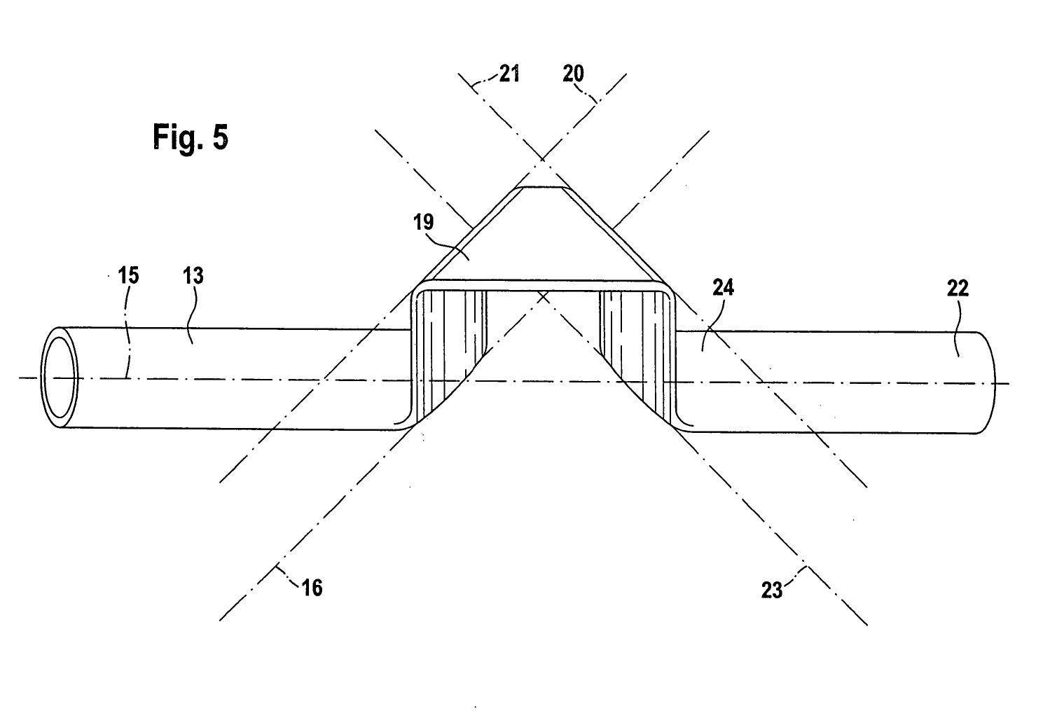

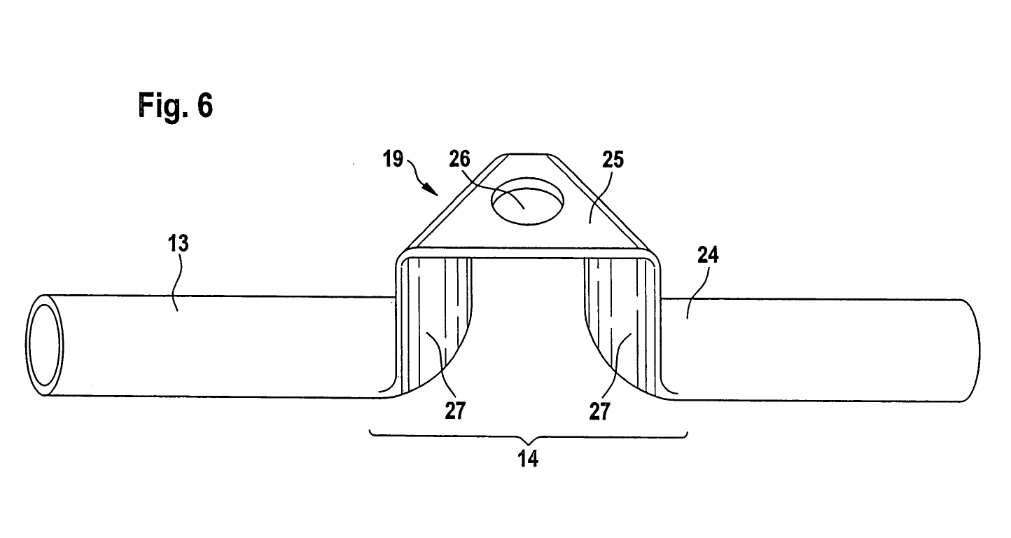

Finally according to FIG. 5 the bent partial section 19 is bent forwards by at least 90° about an axis 23 which is parallel to the horizontal axis 21 and which is separated by a downward vertical distance therefrom, corresponding to the position of the horizontal axis 16 relative to the parallel axis 20, so that an end section 24 of the partial section 19 aligns with the unbent remainder of the member 13. The area 25 of the partial section 19 lying parallel to the remainder of the component 13 is then flattened and the flattened area is thereupon punched to provide a hole 26, which may also be a passage (FIG. 6).

Finally, the hollow member 13 thus formed is placed in an internal high pressure forming tool in which it is exposed to a high internal fluid pressure. This serves to expand not only the unbent area of the member 13 and the end section 24 of the partial section 19, but also to a certain extent the areas 27 of the member 13 projecting upwards at a right angle from the unbent area of the member 13 and from the partial section 19. As a result the vertical areas 27, crumpled relatively heavily during the bending process, recover very approximately the circular cross section of the unbent member 13 and thereby form very flexurally rigid spars.

The spar-like, vertical areas 27 and the flattened area 25 of the partial section 19 together form the mounting component 14. It is moreover also quite feasible in the exemplary embodiment according to FIG. 1 to expand the two hollow profiles 2 and 3 by means of a high internal fluid pressure, so that the bent sections 9, like the vertical areas 27 in the aforementioned exemplary embodiment, acquire a columnar shape, which affords particular flexural and torsional rigidity. The method according to the invention is not limited in its application to motor vehicle construction but may be used wherever elongate, hollow members comprising laterally protruding mounting components are required.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for producing an elongate hollow member that includes a laterally protruding mounting component that is formed from the hollow member, said method comprising:
at a point about a horizontal axis that intersects a central longitudinal axis of the hollow member at an angle of approximately 45°, bending the hollow member upwards or downwards at an angle of approximately 90°, such that a bent section projects laterally in relation to the longitudinal extent of a remainder of the component; and
bending a lateral projection portion of the bent section, such that the lateral projection is angled at an offset height in relation to the remainder of the component, forming the mounting component (14).

2. The method as claimed in claim 1, wherein:
the elongate component is produced using two hollow members arranged in series, opposing ends of which are bent upwards or downwards into an equivalent position about the horizontal axis and laterally inverted in relation to an imaginary axis transverse to the central longitudinal axis of the hollow profiles;
said opposing ends are then angled in the same direction; and
the two hollow members are joined to one another at their angled ends to form the hollow component.

3. The method as claimed in claim 1, wherein:
a partial section of the bent section is bent approximately 90° forwards forward about a further parallel axis separated by a vertical distance from the horizontal axis, running parallel to the central longitudinal axis of the hollow member; and
the partial section is bent further in a lateral inversion of the preceding bending operations until an end section of the partial section aligns with an unbent remainder of the component.

4. The method as claimed in claim 1, wherein the bent section (9, 17) is angled into a horizontal plane.

5. The method as claimed in claim 4, wherein the bent section is flattened in an angled area thereof.

6. The method as claimed in claim 5, wherein the bent section is perforated in its angled area.

7. The method as claimed in claim 5, wherein the flattened area is bent downwards at a right angle at its edge (11) lying parallel to the hollow component (1, 13).

8. The method as claimed in claim 1, wherein, after bending, the hollow component is expanded in an internal high pressure forming tool by means of a high internal fluid pressure.
